(19) United States
(12) Patent Application Publication
(10) Pub. No.: US 2017/0104450 A1
(43) Pub. Date: Apr. 13, 2017

(54) METHOD FOR EVALUATING PERFORMANCE OF PHOTOVOLTAIC MODULE, AND SYSTEM THEREOF

(71) Applicant: Research Cooperation Foundation of Yeungnam University, Gyeongsan-si (KR)

(72) Inventors: Soo Young OH, Daejeon (KR); Won Shoup SO, Daegu (KR); Jae Hak JUNG, Daegu (KR); Chinho PARK, Daegu (KR)

(21) Appl. No.: 14/918,749

(22) Filed: Oct. 21, 2015

(30) Foreign Application Priority Data
Oct. 8, 2015 (KR) 10-2015-0141438

(51) Int. Cl. H02S 50/10

(52) U.S. Cl. CPC H02S 50/10

(57) ABSTRACT

Provided is a method of evaluating performance of a photovoltaic module and a system therefor. The method of evaluating performance of the photovoltaic module according to the present invention has an advantage of more accurately evaluating and predicting a service life and/or performance of the photovoltaic module by reflecting a deterioration index of a photovoltaic module component on a first output value calculated using an electronic-optical diode (E/O diode) model for the photovoltaic module.

### BACKGROUND

1. Field of the Invention

The present invention relates to a method of evaluating performance of a photovoltaic module capable of more accurately evaluating service life of the photovoltaic module by reflecting deterioration of a component generated as time goes by.

2. Discussion of Related Art

As a demand for new and renewable energy has been continuously increasing due to depletion of fossil energy, a photovoltaic industry using solar light has been rapidly growing. Recently, to reduce costs, technology for increasing a service life of a photovoltaic module up to 20 to 25 years has been developed, and thus technology for more accurately evaluating the service life and/or performance of the developed photovoltaic module has been actively researched.

For an example, Patent document 1 discloses technology for evaluating the performance of a solar battery by performing a proximity simulation on various states of the sun using a light similar to the solar light. Also, Patent document 2 discloses a simulation apparatus for inspecting deformation of the photovoltaic module under various climatic conditions.

However, since a degree of deterioration of the module generated as the module is used for long hours in the open air is not reflected, the developed technology, as an accelerated testing method for evaluating performance in a short period of time under a severe condition, has a limitation of low reliability of a result when a photovoltaic module to be used for 20 to 25 years is evaluated.

Therefore, technology for more accurately evaluating performance and/or service life of a photovoltaic module by reflecting deterioration of the photovoltaic module generated as time goes by in the open air is urgently needed.

(Patent document 1) Korean Laid-open Patent Application No. 10-1338801

(Patent document 2) Korean Patent No. 2013-0086762

### SUMMARY OF THE INVENTION

To solve the problem, an object of the present invention provides a method of evaluating performance of a photovoltaic module capable of more accurately evaluating a service life and/or performance of the photovoltaic module by reflecting a deterioration index of a photovoltaic module component according to time.

Another object of the present invention provides a system for evaluating performance of the photovoltaic module capable of performing the method.

In order to achieve the object, in an embodiment of the present invention, there is provided a method of evaluating performance of a photovoltaic module, including: determining a service life of the photovoltaic module by comparing a preset output value with a second output value calculated by applying a deterioration index of a component to a first output value of the photovoltaic module according to time.

In the embodiment of the present invention, there is provided a system for evaluating performance of a photovoltaic module which performs the method of evaluating performance of the photovoltaic module.

As described above, the method of evaluating performance of the photovoltaic module according to the present invention has an advantage of more accurately evaluating and predicting a service life and/or performance of the photovoltaic module by reflecting a deterioration index of a photovoltaic module component on a first output value calculated using an electronic-optical diode model for the photovoltaic module.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an image illustrating a factor and ratio of output degradation caused by durability reduction of a photovoltaic module;

FIG. 2 is a flowchart illustrating a method of evaluating performance of a photovoltaic module according to the present invention in an embodiment;

FIG. 3 is an image in which a photovoltaic module is modeled as a diode in another embodiment; and

FIG. 4 is a graph illustrating a result of an accelerated test of a yellow index of ethylene-vinylacetate (EVA), which is an encapsulating material, by UV stress in still another embodiment.

### DETAILED DESCRIPTION OF EXEMPLARY EMBODIMENTS

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

In the present invention, it will be further understood that the terms “comprise” and/or “include” when used herein, specify the presence of stated features, integers, steps, operations, elements, and/or components, but do not preclude the presence or addition of one or more other features, integers, steps, operations, elements, components, and/or groups thereof.

Also, the attached drawings in the present invention may be exaggerated for convenience of explanation.

Hereinafter, embodiments of the invention will be described in detail with reference to the accompanying drawings. Regardless reference numerals of drawings, like reference numerals refers to like or corresponding elements. Redundant description thereof will be omitted.

The present invention relates to a method of evaluating performance of a photovoltaic module and a system therefor.

Recently, to reduce costs, technology for increasing a service life of a photovoltaic module up to 20 to 25 years has been developed, and thus technology for more accurately evaluating the service life and/or performance of the developed photovoltaic module has been actively researched. However, since a degree of deterioration of the module generated as the module is used for long hours in the open air is not reflected, the developed technology, as an accelerated testing method for evaluating performance in a short period of time under a severe condition, has a limitation of low reliability of a result when a photovoltaic module to be used for 20 to 25 years is evaluated.

Therefore, provided is a method of evaluating performance of a photovoltaic module capable of more accurately evaluating a service life of the photovoltaic module by reflecting deterioration of a component generated as time goes by, and a system therefor.

The method of evaluating performance of the photovoltaic module according to the present invention has an advantage of more accurately evaluating and predicting a service life and/or performance of the photovoltaic module by reflecting a deterioration index of the photovoltaic module component on a first output value calculated using an electronic-optical diode model for the photovoltaic module.

Hereafter, the present invention will be described in more detail.

In the embodiment, the present invention provides a method of evaluating performance of a photovoltaic module which includes determining a service life of the photovoltaic module by comparing a second output value, calculated by applying a deterioration index of a component to a first output value of the photovoltaic module according to time, with a preset output value.

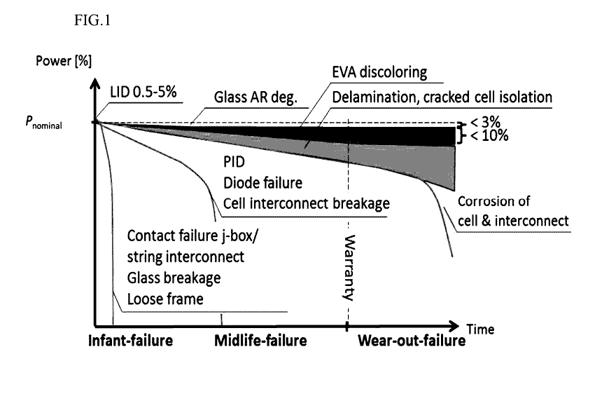

FIG. 1 is an image illustrating a factor and ratio of output degradation caused by durability reduction of a photovoltaic module. The durability of the photovoltaic module is reduced as time goes by, and thus output deterioration of the module is caused. Referring to FIG. 1, causes of the durability degradation of the module may be found out from mainly three kinds of module fails before the durability degradation. Firstly, one of the causes may be an initial fail, such as separation initial fail of a junction box caused by a defect of a material or a problem in a manufacturing process, a string separation, damage to a transparent material like a transparent glass, or damage to the module. Secondly, another cause may be a fail of a potential induced degradation (PID) generated due to other weather conditions or a sudden environment change, a diode defect, or a cell crack. Lastly, the other cause may be a fail generated due to a corrosion of connection or a cell in the long term. In the case of a normal module, durability may be degraded due to various causes as well as the fails. As an example, the durability of the photovoltaic module may be degraded due to, starting from initial light induced degradation (LID), the deterioration of a component, generated as time goes by, specifically, detachment of an anti-reflection (AR) coating, yellowing of an encapsulating material, delamination of a cell, corrosion of a cell, and the like. The durability degradation of the module generated due to the various causes may function as a factor reducing output of the module.

Therefore, the method for evaluating performance of the photovoltaic module according to the present invention includes, to predict a result more accurately than when the performance of the photovoltaic module predicted to be used for 20 to 25 years is evaluated, determining a service life and/or performance of the photovoltaic module by comparing a preset effective output value with a second output value of the photovoltaic module calculated by reflecting a deterioration index of a component, affecting the durability of the module, on a first output value of the photovoltaic module according to time.

Specifically, in the method of evaluating performance, the determining of a service life of the photovoltaic module may include: calculating the first output value of the photovoltaic module according to time; calculating the second output value of the photovoltaic module by applying a deterioration index of a component to the calculated first output value; and determining a service life of the photovoltaic module from a point of time in which the second output value is less than or equal to the preset output value by comparing the second output value with the preset output value.

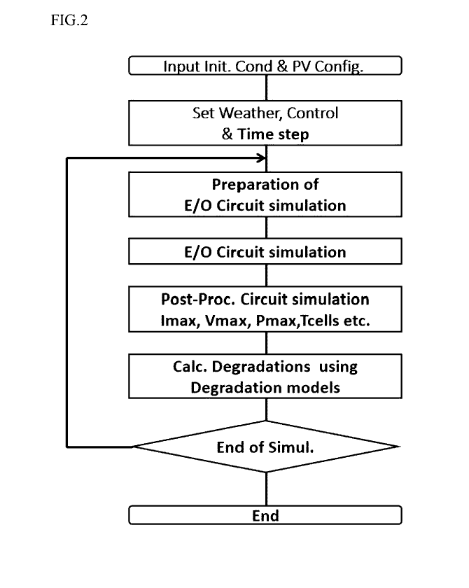

FIG. 2 is a flowchart illustrating a method of evaluating performance of a photovoltaic module according to the present invention in an embodiment. Hereafter, referring to FIG. 2, the method of evaluating performance of the photovoltaic module will be described in detail.

Firstly, the method of evaluating performance of the photovoltaic module according to the present invention includes calculating the first output value of the photovoltaic module according to time.

The first output value, which is a nominal power, a maximum power voltage (Vₘₚ), a maximum power current (Iₘₚ), an open circuit voltage (V_{oc}), a short-circuit current (I_{sc}), a series resistance (Rₛ), or the like that represents a service life and/or performance of the photovoltaic module, may be calculated through a simulation in which a module property is modeled as an electric phenomenon under conditions of a size of the module, a weather condition under which the module is installed, and an output condition of the module.

Specifically, to calculate the first output value, parameters, such as I_{sc0}, Iₘₚ, V_{oc}, Vₘₚ, δ(T_{c}) presenting an instantaneous power amount of the photovoltaic module, are calculated using Equations 1 to 5 below:

I_{sc0}=I_{sc}/[Eₑ·{1+α_{Isc}·(T_{c}−T₀)}] Equation 1:

Iₘₚ=Iₘₚ₀·[C₀·Eₑ+C₁·Eₑ²}·{1+α_{Imp}·(T_{c}−T₀)} Equation 2:

V_{oc}=V_{oc0}+Ns·δ(T_{c})·ln(Eₑ)+β_{Voc}(Eₑ)·(T_{c}−T₀) Equation 3:

Vₘₚ=Vₘₚ₀+C₂·Nₛ·δ(T_{c})·ln(Eₑ)+C₃·Nₛ·{δ(T_{c})·ln(Eₑ)}²+β_{Vmp}(Eₑ)·(T_{c}−T₀) Equation 4:

δ(T_{c})=n·k·(T_{c}+273.15)/q Equation 5:

In the Equations 1 to 5,

I_{sc}=short-circuit current [A]

Iₘₚ=maximum power current [A]

V_{oc}=open circuit voltage [V]

Vₘₚ=maximum power voltage [V]

α_{Isc}=temperature correction factor of the value I_{sc}[1/° C.]

α_{Imp}=temperature correction factor of the value I_{sc}[1/° C.]

β_{Voc}(Eₑ)=β_{Voc}+m_{βVoc}·(1−Eₑ), temperature correction factor of the open circuit voltage, m_{βVoc}=0

β_{Vmp}(Eₑ)=β_{Vmp}+m_{βVmp}·(1−Eₑ), temperature correction factor of the open circuit voltage, m_{βVmp}=0

β_{Vmp0}=temperature correction factor of the module in an insolation amount of 1000 W/m² [V/° C.]

T₀=reference temperature of a cell, generally 25° C.

T_{c}=cell temperature in the module

C₀, C₁=empirical variable for insolation amount, C₀+C₁=1 [nondimension]

C₂, C₃=empirical variable for insolation amount [C₂→nondimension, C₃→1/V]

δ(T_{c})=thermal voltage per cell in a cell temperature in the module

Eₑ=effective insolation amount in which solar light approaches the cell through a transparent base material of the module by an angle of altitude

Nₛ=number of cell connected to the module

q=1.60218 E⁻¹⁹

k=Boltzmann constant, 1.38066 E⁻²³ [J/K]

When the parameters representing the instantaneous power amount of the photovoltaic module are calculated, as shown in FIG. 3, the parameters for electrical properties related to the durability of the module is derived by modeling the photovoltaic module as a diode. At this time, the parameters, which are Aₚₕ, Iₛₐₜ, m, Rₛ, and Rₛₕ that represent the electrical properties, may be calculated from Equations 6 to 9 based on the conditions of I_{sc0}, Iₘₚ, V_{oc}, and Vₘₚ calculated through the Equations 1 to 5:

Iₚₕ=AₚₕI_{sc0}Eₑ Equation 6:

I_{diode}=Iₛₐₜ[exp(V_{cell}+I_{cell}Rₛ/mVₜ)−1] Equation 7:

V_{T}=kT_{cell}/q Equation 8:

Iₛₕ=V_{cell}+I_{cell}Rₛ/Rₛₕ Equation 9:

In the Equations 6 to 9,

Iₚₕ=generated current of the photovoltaic module

Aₚₕ=variable depending on Eₑ and a temperature of cell T_{cell}

I_{diode}=current flowing in the diode

Iₛₐₜ=saturation current

V_{cell}=voltage of the cell

I_{cell}=current of the cell

V_{T}=voltage by the temperature

Iₛₕ=current flowing to a series resistance

Rₛ=series resistance

Rₛₕ=parallel resistance

m=diode variable

When the parameters, representing electrical properties related to the instantaneous power amount of the photovoltaic module and the durability of the module, are derived through Equations 1 to 9, a first output value may be calculated by simulating an electro-optical diode model (E/O diode model) in which a module property is modeled with an electrical phenomenon.

In this case, the simulation may be performed with the derived parameters under actual conditions in which the photovoltaic module is used, for example, weather conditions represented with an air temperature and insolation amount changed at a point at which the photovoltaic module is installed in real time, a size condition represented with the number of cells connected to the module, an area of the cell, a reference temperature of the module, and the like, a time condition in which evaluation is performed, and an output condition of the module represented with a current and voltage condition for simulating a current-voltage curve of the photovoltaic module and the like. At this time, when a condition for the insolation amount of the weather conditions is not present, altitude and azimuth angles of the sun according to latitude of a point at which the module is installed may be used.

In the simulation, an electrical signal received from the diode model is computed in real time using the E/O diode model, and also heat energy, generated by power generation, energy discharged to the outside, and the like are computed, and thus an electrical flow in the module is easily understood.

Next, the method of evaluating performance of the module according to the present invention includes calculating the second output value of the photovoltaic module by applying a deterioration index of a component to the calculated first output value.

Specifically, the calculating of the second output value includes simulating the deterioration of the photovoltaic module by applying a deterioration index of the module component, such as detachment of AR coating, yellowing of an encapsulating material, delamination of a cell, and corrosion of a cell that are generated as time goes by, to the calculated first output value, and obtaining the output value (that is, the second output value) of the module predicted through the simulation, wherein the predicted output value of the module may be a nominal power, a maximum power voltage (Vₘₚ), a maximum power current (Iₘₚ), an open circuit voltage (V_{oc}), a short-circuit current (I_{sc}), a series resistance (Rₛ), and the like that represent the service life and/or performance of the photovoltaic module.

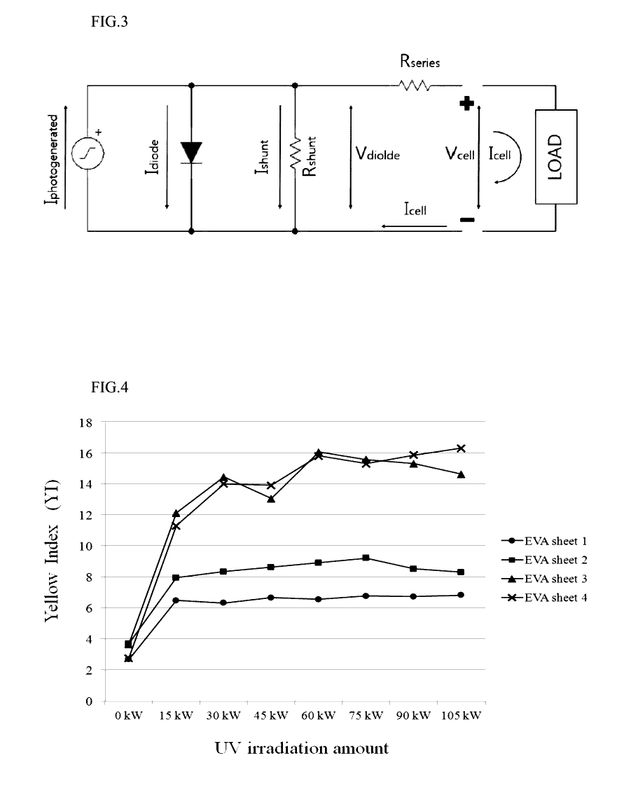

Also, the deterioration index of a component may be the deterioration index of a component of the photovoltaic module measured or simulated with respect to materials as a unit under at least one condition selected from the group consisting of a temperature, insolation amount, and humidity of a point at the photovoltaic module is installed. For an example, when a yellow index (YI), caused by ultraviolet rays, of an EVA sheet, which is an encapsulating material, is applied as a deterioration index, EVA sheets for the photovoltaic module on the market are manufactured or prepared with respect to manufacturers, and a small-scale module (6 cm×10 cm) configured of transparent glass-EVA-EVA-backsheet except for a cell portion is manufactured in the same method as the actual module. The manufactured module is exposed under a condition of the actual module or, as shown in Table 4 below and FIG. 4, values are generated by irradiating the manufactured module with ultraviolet rays of 105 kW.

TABLE 4

| UV irradiation | | | | |
|---|---|---|---|---|
| amount | EVA sheet 1 | EVA sheet 2 | EVA sheet 3 | EVA sheet 4 |
| 0 kW | 2.7 | 3.72 | 3.68 | 2.78 |
| 15 kW | 6.49 | 7.97 | 12.14 | 11.32 |
| 30 kW | 6.34 | 8.37 | 14.47 | 14.03 |
| 45 kW | 6.69 | 8.65 | 13.08 | 13.94 |
| 60 kW | 6.58 | 8.93 | 16.08 | 15.82 |
| 75 kW | 6.78 | 9.24 | 15.6 | 15.32 |
| 90 kW | 6.76 | 8.55 | 15.32 | 15.88 |
| 105 kW | 6.84 | 8.32 | 14.65 | 16.32 |

Since the module is manufactured in the same configuration and method as the actual module except for the cell, the measured YI may reflect YIs, facilitated according to a change in a temperature and insolation in the actual module and changed depending on the kinds of EVA sheets, and thus the reliability of the measured result may be improved. Also, since the YIs according to the kinds of materials such as the transparent film or a backsheet other than the EVA sheet used for the encapsulating material may be individually measured and applied, the deterioration index of the module according to the kinds of the materials may be applied from various aspects.

Lastly, the method of evaluating performance of the photovoltaic module according to the present invention includes determining the performance and/or service life of the photovoltaic module by comparing the preset output value with the calculated second output value.

Specifically, the determining may include determining the performance and/or service life of the photovoltaic module by computing the number of performance evaluation days of the module starting from a point where the calculated second output value is less than or equal to the preset output value by comparing the second output value with the preset output value. Here, the preset output value, as a criterion determining the service life and/or performance of the photovoltaic module, may be set with respect to the maximum output value in which the initial photovoltaic module generates power. For an example, the preset output value may be an output value corresponding to 80% of the maximum power value in which the initial photovoltaic module generates power, but is not limited thereto.

Also, in the embodiment, the present invention provides a system for evaluating performance of the photovoltaic module configured to perform the method of evaluating performance of the photovoltaic module.

The system for evaluating performance of the photovoltaic module according to the present invention comprises: an input unit configured to input a condition under which the photovoltaic module is operated and a preset output value which is a criterion determining the service life and/or performance of the photovoltaic module; and a computing unit configured to calculate the first output value applied with an operational condition, input from the input unit, using the E/O diode model for the photovoltaic module, calculate the second output value by applying the deterioration of a component to the calculated first output value, and determine the service life and/or performance of the photovoltaic module by comparing the calculated second output value with the preset output value, wherein the deterioration index of the component may be extracted from a database which includes the deterioration indexes of the photovoltaic module components with respect to a condition, in which the component is deteriorated, and/or materials as a unit.

In this case, the operational condition, input into the input unit, may be a weather condition, represented with an air temperature and insolation amount changed at a point, at the photovoltaic module is installed, in real time, a size condition, represented with the number of cells connected to the module, an area of the cell, a reference temperature of the module, and the like, a time condition in which evaluation is performed, and an output condition of the module represented with a current and voltage condition for simulating a current-voltage curve of the photovoltaic module and the like, as well as the parameters representing electrical properties related to the durability of the module and the instantaneous power amount of the photovoltaic module. Also, when a condition for the insolation amount of the weather condition is not present, the altitude and azimuth angles of the sun according to latitude of a point at which the module is installed may be input.

Furthermore, the computing unit may calculate the first output value to a value, such as of a nominal power, a maximum power voltage (Vₘₚ), a maximum power current (Iₘₚ), an open circuit voltage (V_{oc}), a short-circuit current (I_{sc}), and a series resistance (Rₛ), by performing the simulation using the electronic-optical diode model, in which the module property is modeled with an electrical phenomenon, under the conditions of the size of module, the weather condition of a point at the module is installed, and the output condition of the module.

The system for evaluating performance of the photovoltaic module according to the present invention may easily and more accurately perform a state analysis on an indoor accelerated test simulation or an outdoor simulation by reflecting the deterioration index of the photovoltaic module component at the time of performance evaluation of the photovoltaic module.

What is claimed is:

1. A method of evaluating performance of a photovoltaic module, comprising:
determining a service life of the photovoltaic module by comparing a preset output value with a second output value calculated by applying a deterioration index of a component to a first output value of the photovoltaic module according to time.

2. The method of claim 1, wherein the first output value is calculated by an electronic-optical diode (E/O diode) model for the photovoltaic module.

3. The method of claim 1, wherein the first output value is calculated from a size of the module, a weather condition at the module is installed, and an output condition of the module.

4. The method of claim 1, wherein the first and second output values are at least one selected from a group consisting of a nominal power, a maximum power voltage, a maximum power current, an open circuit voltage, a short-circuit current, and a series resistance.

5. The method of claim 1, wherein the deterioration index of the component is at least one selected from a group consisting of detachment of an anti-reflection (AR) coating, a yellow index (YI) of an encapsulating material, delamination of a cell, and corrosion of a cell.

6. The method of claim 1, wherein the deterioration index of the component is a YI of an encapsulating material.

7. The method of claim 1, wherein the deterioration index of the component is extracted from a database measured under at least one condition selected from a group consisting of a temperature, insolation amount, and humidity of a point at the photovoltaic module is installed.

8. The method of claim 1, wherein the determining of the service life of the photovoltaic module comprises: calculating the first output value of the photovoltaic module according to time; calculating the second output value of the photovoltaic module by applying the deterioration index of the component to the calculated first output value; and determining a service life of the photovoltaic module from a point of time in which the second output value is less than or equal to the preset output value by comparing the calculated second output value with the preset output value.

9. A system for evaluating performance of a photovoltaic module configured to perform the method of evaluating performance of the photovoltaic module according to claim 1.

10. The system of claim 9, wherein the system for evaluating performance of the photovoltaic module comprises a database including deterioration indexes of the photovoltaic module components with respect to materials as a unit.
